(19) United States
(12) Patent Application Publication
(10) Pub. No.: US 2016/0106177 A1
(43) Pub. Date: Apr. 21, 2016

(54) TRACEABLE FOOTWEAR, TRACKING SYSTEM FOR SAID FOOTWEAR AND NETWORK APPLICATION FOR SAID TRACKING

(71) Applicant: DELMA IMMOBILIARE S.R.L., Pescara (IT)

(72) Inventor: Massimo DE LAURENTIS, VIGEVANO (IT)

(21) Appl. No.: 14/891,938

(22) PCT Filed: May 21, 2014
(86) PCT No.: PCT/IB2014/061584

§ 371 Date: Nov. 17, 2015

(30) Foreign Application Priority Data
May 22, 2013 (IT) MI2013A000833
May 15, 2014 (IT) MI2014A000891

(51) Int. Cl. A43B 3/00; G08B 21/02; A41D 1/00

(52) U.S. Cl. CPC A43B 3/0005; A41D 1/002; G08B 21/0272

(57) ABSTRACT

The invention describes a traceable footwear (1), particularly for children, including a circuit terminal mounted (11) permanently in the footwear (1); a housing (12) formed in the footwear (1) itself including a first electrical contact (13) connected to the circuit terminal (11); a movable component (14) removably inserted in the housing (12); at least one presence detection sensor for detecting the presence of a part of a living body (102) positioned in the movable component (14), wherein the movable component (14) includes a presence detection system for detecting the presence of a human being (17), configured for detecting a parameter representative (Pres) of the presence of a human being; and a position detection system (18) configured for detecting a position of the footwear (1). The invention furthermore describes a tracking system (100) and a data processing system (50) configured for interacting with the tracking system (100).

### FIELD OF THE APPLICATION

The present invention relates to a traceable footwear.

The present invention also relates to a tracking system for such footwear.

The present invention furthermore relates to a network application for said tracking.

The present invention is addressed particularly to a public of children, who surely represent the people most needing to be able to be monitored, both because of their intrinsic unpredictability in their movements, and because of cases where they may be the object of attentions and/or abduction by ill-intentioned people.

### PRIOR ART

Tracking systems for footwear and corresponding footwear are known which comprise complex data transceiving structures; to all intents and purposes, these structures are assimilable to radio transceivers which are complex to manufacture and of considerable dimensions.

These devices are for the most part used to monitor the movements of adults and elderly people with particular illnesses connected with memory loss, particularly Alzheimer's disease; these people often, due to their illness, are not capable of finding their way back home and are tracked with these devices.

The dimensions of the transmission device are considerable.

A different field of application is represented by footwear for children; the small dimensions and the mot varied and intense stresses require solutions more complex than those which can be envisaged for traceable shoes known for adults.

An object of the present invention is to create a traceable shoe of simple construction compared with the known art.

A particular object of the present invention is to create a traceable shoe of simple and economical technology and compact dimensions.

Another object of the present invention is to create a tracking system for footwear which is easy to use and of proven efficiency.

A further object of the present invention is to provide a control device for said tracking system which is easy to manage and operates in real time.

### SUMMARY OF THE INVENTION

These and other objects are achieved by a traceable footwear according to the inventions described herein.

These and other objects are achieved by a tracking system for said traceable footwear according to the inventions described herein.

These and other objects are achieved by a network application for said tracking according to the inventions described herein.

The invention, as described, achieves the following technical effects:
easy traceability of the footwear for all types of user, child or adult;
ease of use of the system;
efficient detection even at great distances;
possible detection of the position of people affected by mental illnesses which inhibit the orientation system.
Possible tracking of geographical position by navigation towards a preset position.
tracking the geographical position of people in danger of aggression.
storage of the route travelled and pedometer.

The technical effects mentioned and other technical effects of the invention will emerge in more detail from the description, given below, of an embodiment shown by way of indicative and non-limiting example with reference to the attached drawings.

### BRIEF DESCRIPTION OF THE DRAWINGS

FIG. 1 is a first schematic view of a traceable footwear according to the invention.

FIG. 2a is a block diagram of a first embodiment of a component of the footwear of FIG. 1.

FIG. 2b is a block diagram of a second embodiment of a component of the footwear of FIG. 1.

FIG. 2c is a block diagram of a third embodiment of a component of the footwear of FIG. 1.

FIG. 3 is a block diagram of another component of the footwear of FIG. 1.

FIG. 4 is a block diagram of a tracking system of the footwear of FIGS. 1 and 2.

FIG. 5a is a second schematic view of the traceable footwear according to the invention.

FIG. 5b is a schematic view of a movable component of the traceable footwear of FIG. 1.

FIG. 6 is a block diagram of a network application configured for acting with the tracking system of FIG. 4.

FIG. 7 shows schematically a first embodiment of a system for detecting the presence of a part of a living body integrated into the traceable footwear of FIGS. 1 and 2.

FIG. 8 shows schematically a second embodiment of a system for detecting the presence of a part of a living body integrated into the traceable footwear of FIGS. 1 and 2.

FIG. 9 shows schematically a third embodiment of a system for detecting the presence of a part of a living body integrated into the traceable footwear of FIGS. 1 and 2.

FIG. 10A shows schematically a first embodiment of a method for detecting the presence of a part of a living body integrated into the traceable footwear of FIGS. 1 and 2.

FIG. 10B shows schematically a first embodiment of a method for detecting the presence of a part of a living body integrated into the traceable footwear of FIGS. 1 and 2.

### DETAILED DESCRIPTION

A traceable footwear, particularly for children, comprises a circuit terminal mounted permanently in the sole, and a housing formed in the sole itself comprising a first electrical contact connected to the circuit terminal. The footwear comprises furthermore a movable component removably inserted in said housing, at least one detection sensor for detecting the presence of a part of a living body positioned in the movable component, wherein the movable component comprises a detection system for detecting the presence of a human being, configured for detecting a parameter representative of the presence of a human being depending on a detection signal indicative of the presence or absence of an object in proximity to the detection sensor for detecting the presence of a part of a living body, and a position detection system configured for detecting a position of the footwear depending on the presence detected of a human being.

The invention provides for integration into to a footwear capable of allowing the movements of a subject, particularly of a child, to be tracked, provided that it is assumed that the movements of the subject always occur after putting on a footwear.

The invention therefore comprises a part integrated into the footwear and a centralized detection system for detecting information so that it can provide a user, in real time and on request, the information for locating the footwear and, consequently, the subject monitored.

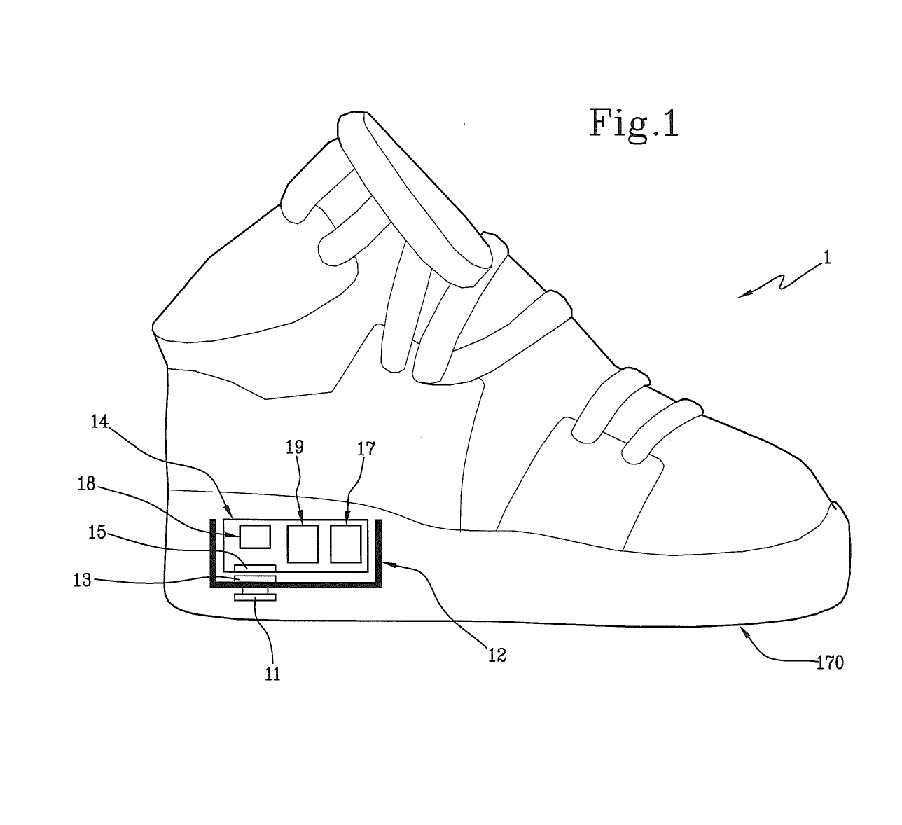

With particular reference to FIG. 1, the traceable footwear 1, particularly for children, comprises a circuit terminal 11.

Advantageously, according to the invention, the circuit terminal 11 is mounted permanently in the footwear 1.

Preferably, this circuit terminal 11 is mounted in the sole 170 of the footwear 1.

The traceable footwear 1 comprises a housing 12, preferably formed in the sole 170 of the footwear 1.

Preferably, the circuit terminal 11 and/or the housing 12 are comprised in the heel of the footwear, where the term ‘heel’ is intended to mean a prominence on the sole 170 of the footwear 1 located under the heel of the foot.

The housing 12 comprises a first electrical contact 13 connected to the circuit terminal 11.

Advantageously, according to the invention, the footwear 1 comprises furthermore a movable component 14 configured for being removably inserted into the housing 12.

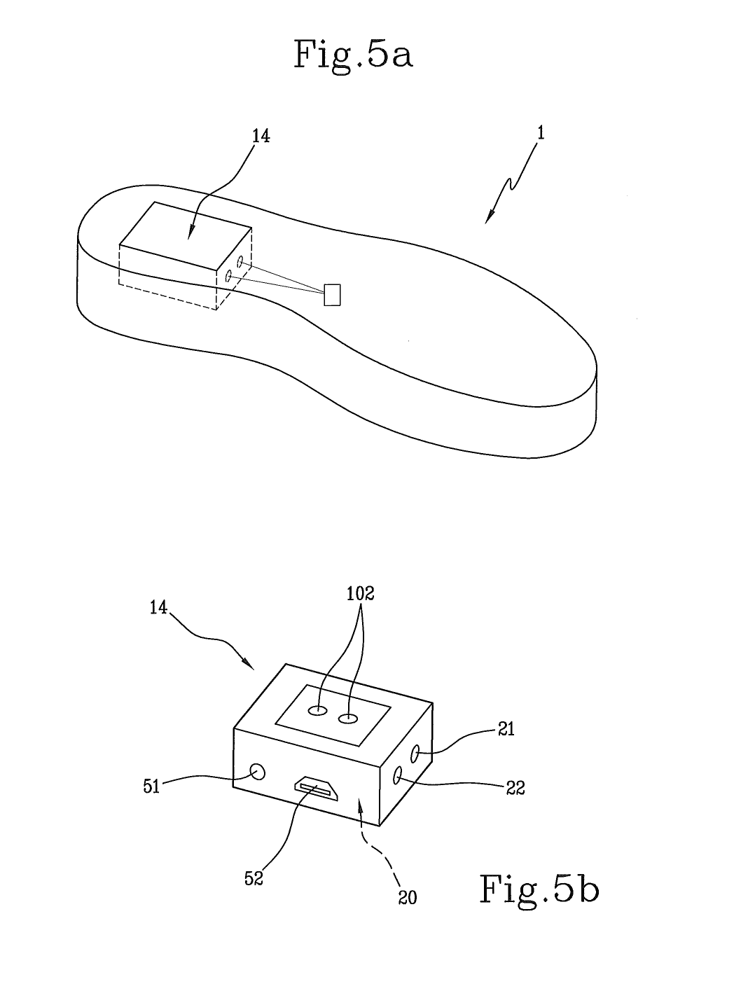

With particular reference to FIG. 5b, the movable component 14 is preferably realized as a plastic container consisting of two interlocking parts whose closure is assured by means of an ordinary screw or an interlocking closure system.

This movable component 14 is configured for being able to be opened and reclosed easily by the user in order to be able to have inserted therein a suitable data transmission device, on request.

Preferably, the movable component 14 has two holes 51, 52:
a first hole 51 for the connector of a recharging device for recharging a battery;
a second hole 52 for a USB connection for updating the contained software.

Preferably, the movable component 14 has on one side metal contacts 21, 22 configured for coming into contact with the first electrical contact 13 present in the housing 12 formed in the sole of the footwear.

The movable component 14 is provided with a second electrical contact 15.

Advantageously, according to the invention, the first 13 and second 15 electrical contact are configured for entering into reciprocal contact depending on the insertion of the insertion of the movable component 14 into the housing 12.

According to the invention, the movable component 14 comprises at least one detection sensor for detecting the presence of a part of a living body 102.

This sensor can be realized according to various construction criteria depending on the specific necessities of detection.

In one embodiment, the at least one detection sensor for detecting the presence of a part of a living body 102 comprises an optical sensor.

Advantageously, according to the invention, the optical sensor 102 comprises an emitter of electromagnetic radiation in the infrared band.

Furthermore, the optical sensor 102 comprises a photoelectric sensor configured for detecting reflected radiation and generating therefrom a first infrared detection signal S_IR1 indicative of the presence or absence of an object in proximity to the optical sensor.

Advantageously, according to the invention, the movable component 14 comprises a detection system 17 for detecting the presence of a human being.

This presence detection system 17 is configured for detecting a parameter Pres representative of the presence of a human being when the first 13 and second 15 contacts are in reciprocal contact.

Advantageously, according to the invention, the presence detection system 17 is configured for detecting the parameter Pres depending on a first detection signal S_IR1 indicative of the presence or absence of an object in proximity to the detection sensor for detecting the presence of a part of a living body 102.

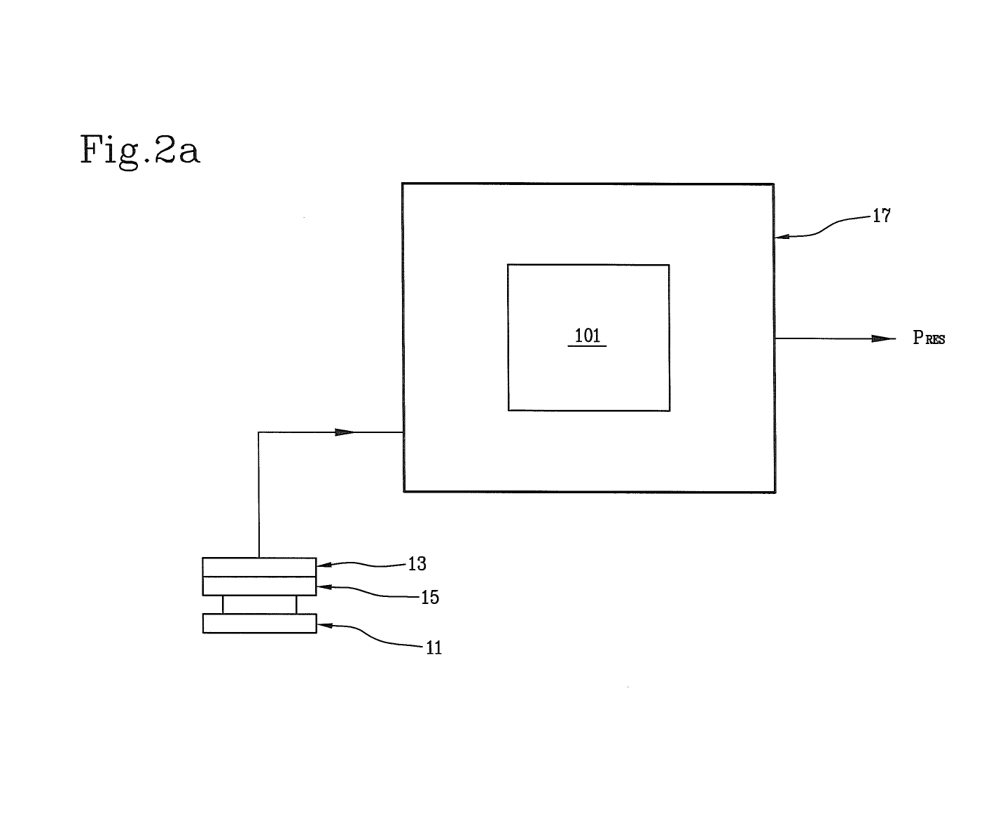

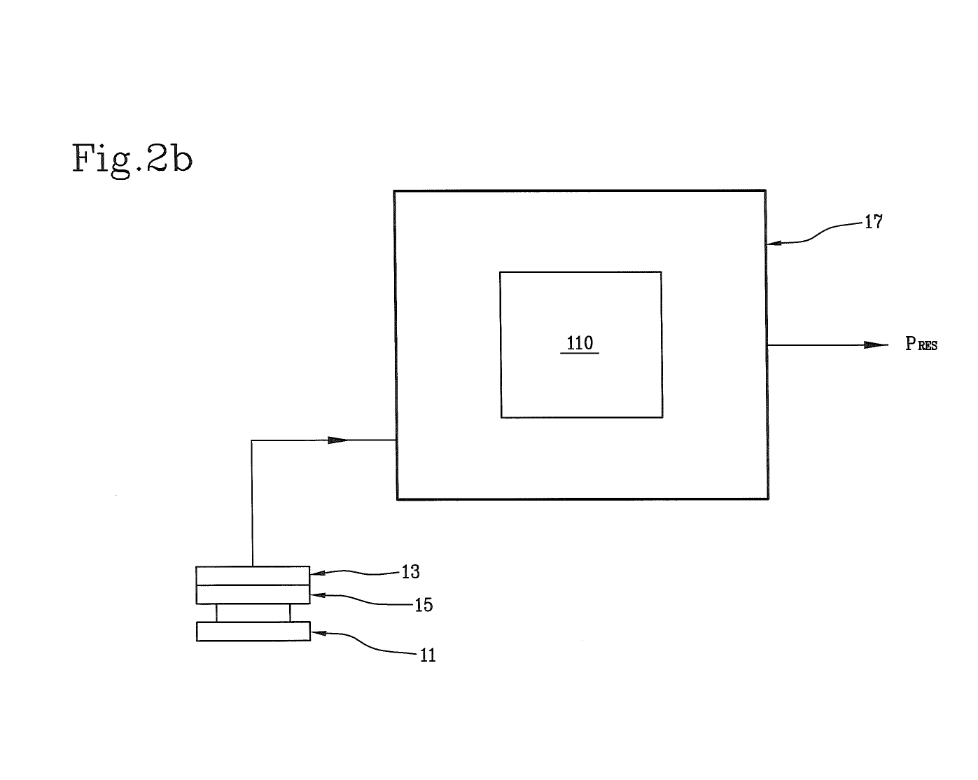

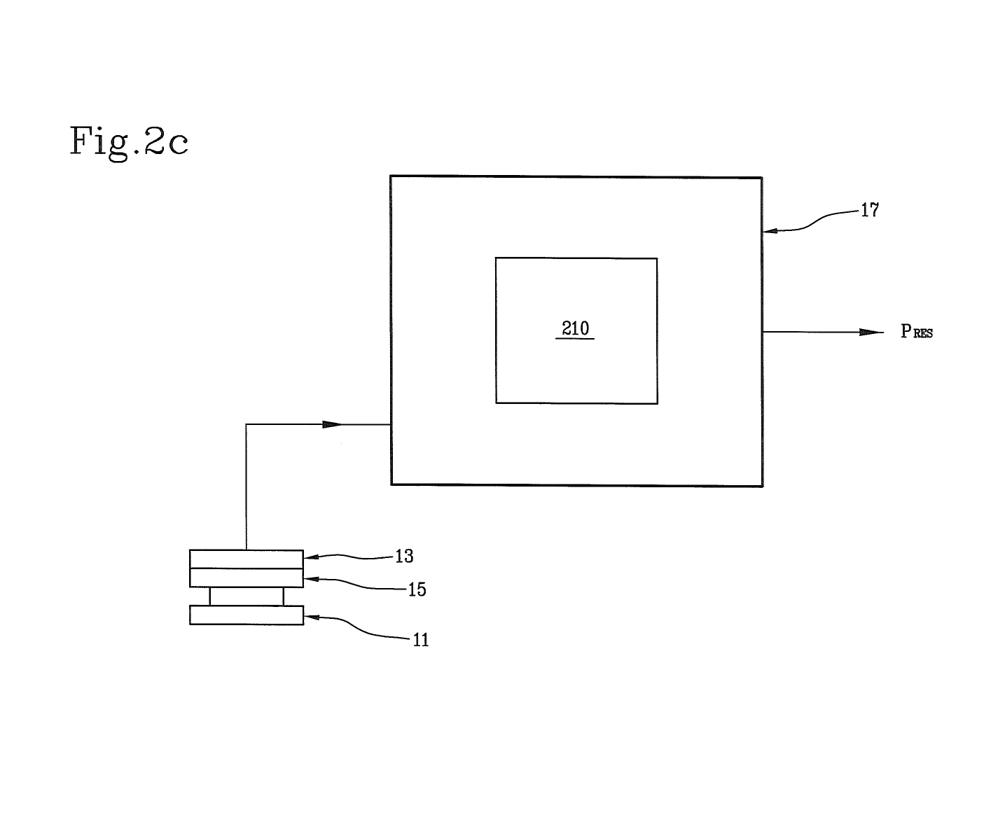

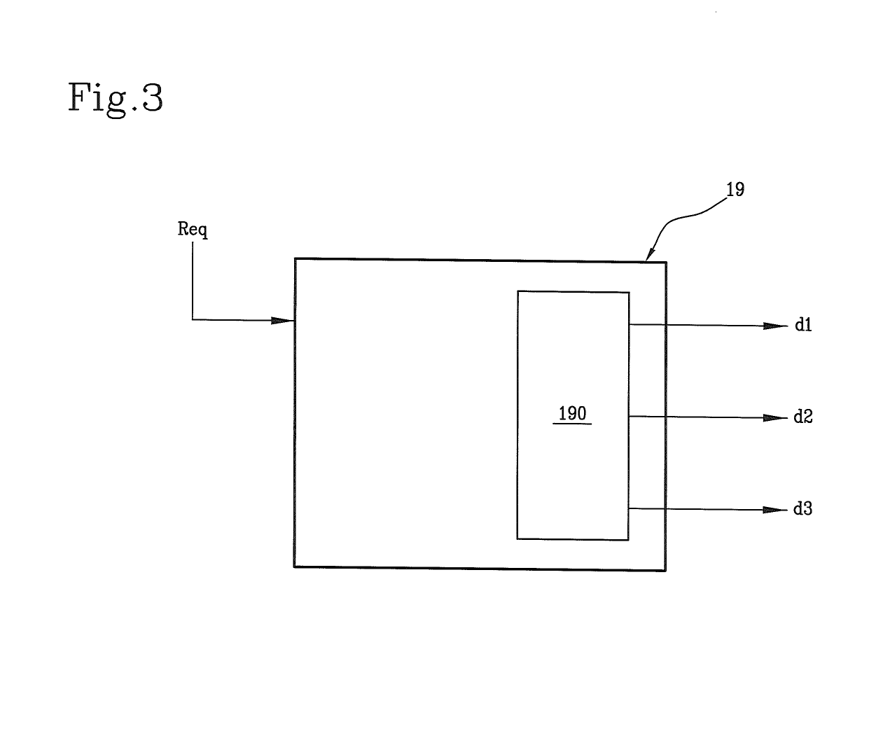

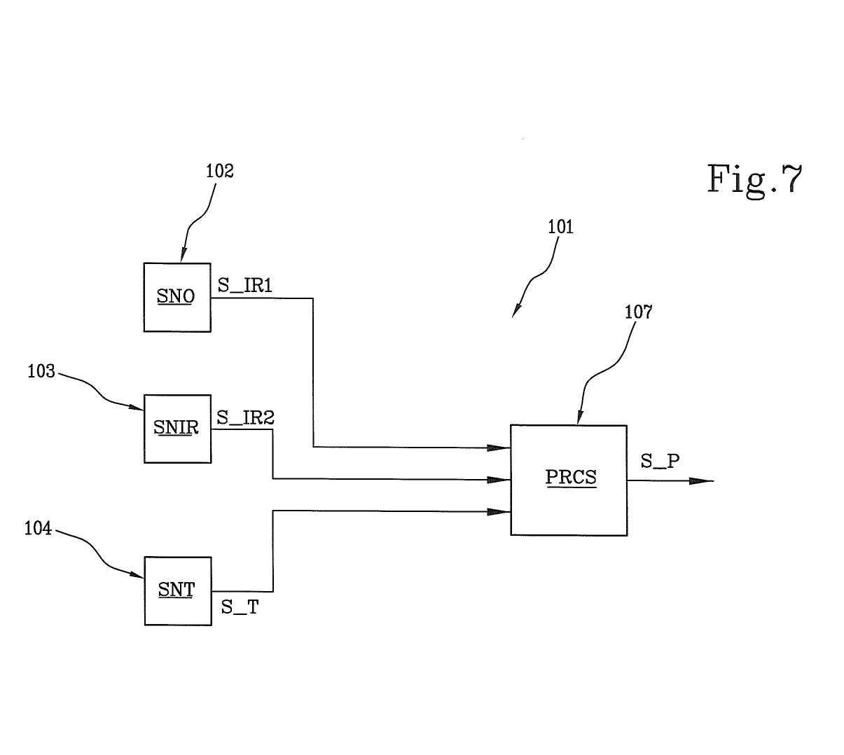

With reference to FIG. 7, a first embodiment is shown of a system for the detection of the presence of a part of a living body, indicated below by 101, 110 and 210, and comprised in the presence detection system 17 for detecting the presence of a human being; this, in its turn, being integrated into the traceable footwear of FIGS. 1 and 2.

The term ‘living body’ is intended to mean a human or animal body; a part of the human body is for example a hand or a foot.

It should be noted that in the present description identical or similar blocks, components or modules are indicated in the drawings by the same reference numbers.

There will now be described a system for detecting the presence of a part of a living body 101 comprised in the presence detection system 17 for detecting the presence of a human being.

The detection system 101 comprises the detection sensor for detecting the presence of a part of a living body 102, an infra-red sensor 103, a temperature sensor 104 and a processing module 107.

The detection sensor for detecting the presence of a part of a living body 102 has the function of detecting the presence of an object positioned in proximity to the detection sensor for detecting the presence of a part of a living body 102 and therefore positioned in proximity to the system 101.

In particular, the detection sensor for detecting the presence of a part of a living body 102 comprises an optical sensor 102.

In particular, the optical sensor 102 comprises an emitter such as to generate pulses of electromagnetic radiation in the infra-red band and comprises a photoelectric sensor such as to detect the radiation reflected by the object and generate from the latter a first infra-red detection signal S_IR1 indicative of the presence of the object in proximity to the optical sensor 102 or indicative of the absence of the object. For example, the first infra-red detection signal S_IR1 is a logical signal having a first value (for example, high) to indicate the presence of the object in proximity to the detection system 101 and having a second value (in the example, low) to indicate the absence of the object.

The optical sensor 102 is made for example with the integrated circuit SFH 9240 sold by Osram Opto Semiconductors GmbH (www.osram-os.com) or with the integrated circuit CNY70 sold by Vishay Semiconductors (www.vishay.com).

The infra-red sensor 103 has the function of detecting the infra-red radiation emitted by a part of a living body positioned in proximity to the infra-red sensor 103 and therefore positioned in proximity to the system 101.

It is known in fact that the human body has a body temperature generally higher than the surrounding atmosphere and thus emits heat in the form of electromagnetic radiation in the infra-red band. The infra-red sensor 103 is such as to detect the electromagnetic radiation in the infra-red band emitted by a part of the human body and, depending thereon, is such as to generate a second infra-red detection signal S_IR2 indicative of the presence or absence of a part of a living body in proximity to the infra-red sensor 3.

The infra-red sensor 103 is therefore of passive type (indicated in English as PIR=Passive Infra-Red), i.e. it is such as not to generate any infra-red radiation, but is such as to passively detect in input the infra-red radiation emitted by the object itself.

The passive infra-red sensor 103 is made for example with the integrated circuit IRS-B210ST01-R1 sold by Murata (www.murata.com).

The temperature sensor 104 has the function of detecting the temperature of an environment present in the vicinity of a part of a living body positioned in proximity to the temperature sensor 104 and therefore positioned in proximity to the system 101. In particular, the temperature sensor 104 is such as to generate a temperature detection signal S_T indicative of the temperature of the environment present near a part of a living body positioned in proximity to the temperature sensor 104.

For example, the temperature detection signal S_T is an analogue voltage signal proportional to the value of the temperature of the environment near the part of a living body positioned in proximity to the temperature sensor 104.

For example, the part of a living body is a man's foot and the environment is a shoe. When the foot is inserted into the shoe, after a few minutes the temperature of the foot (which is assumed to be equal to 36° C.) causes an increase in the temperature of the environment inside the shoe (for example, 38° C.). Said temperature increase is detected by the temperature sensor 104, which generates the temperature detection signal S_T having a value indicative of the temperature inside the shoe.

The temperature sensor 104 is made for example with the integrated circuit LM35 sold by Texas Instruments (www.ti.com).

It should be observed that the combination of the optical sensor 102, the infra-red sensor 103 and the temperature sensor 104 is particularly advantageous because it makes it possible to reliably detect the presence of a part of a living body located in proximity to said sensors, given that the number of false alarms which can be generated by the individual sensors is reduced. Furthermore, the available optical, infra-red and temperature sensors have compact dimensions and therefore the detection system 101 can be positioned even in small spaces, such as for example in a shoe, to detect the presence of the foot in the shoe itself, or in garments to detect that the garment has been put on, or in other clothing accessories.

The processing module 107 is connected to the optical sensor 102, the infra-red sensor 103 and the temperature sensor 104. The processing module 107 is such as to receive the first infra-red detection signal S_IR1 from the optical sensor 102, the second infra-red detection signal S_IR2 from the infra-red sensor 103 and the temperature detection signal S_T from the temperature sensor 104 and, depending thereon, is such as to generate a presence signal S_P indicative of the presence of a part of a living body in proximity to the detection system 101 or indicative of the absence of the part of the living body, as will be explained in more detail below in the description relating to operation. In particular, the processing module comprises a first sub-module for processing the first infra-red detection signal S_IR1 and comprises a second sub-module for processing the second infra-red detection signal S_IR2 and the temperature detection signal S_T.

The processing module 107 is for example a micro-processor.

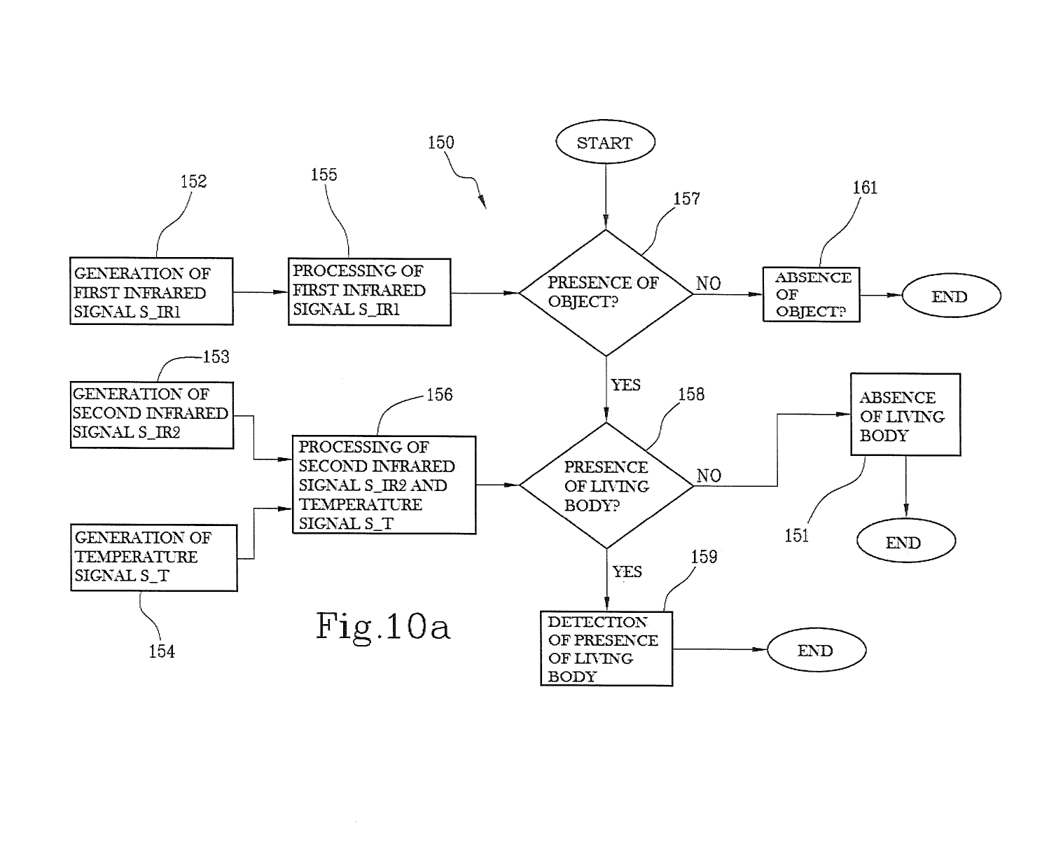

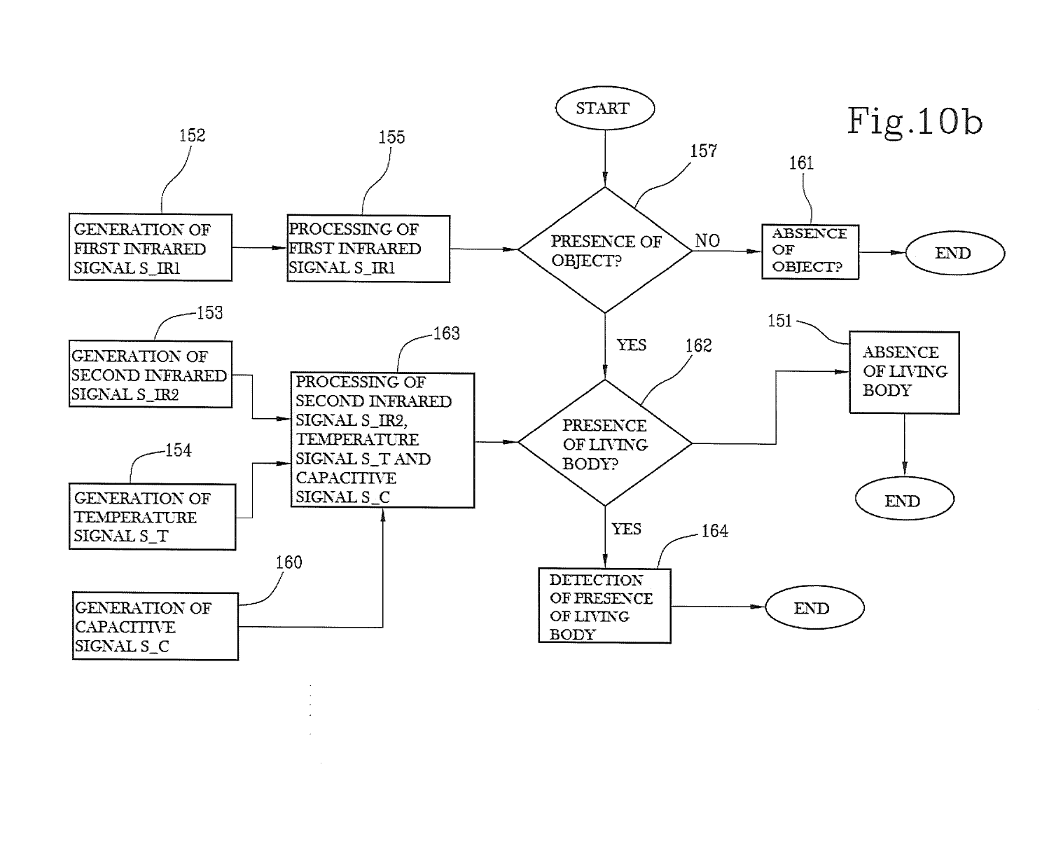

In particular, the processing module 107 is such as to execute software code which implements part of a method 150 for detecting the presence of a part of a living body, as shown in FIG. 10A; more particularly, the processing module 107 executes steps 155, 156, 157, 158, 159, 151, 161, as will be explained in more detail below in the description relating to operation.

In the method 150 shown in FIG. 10A it may be observed that there is first a stage (see step 157) in which is detected the presence or absence of an object in proximity to the detection system 101: in this stage it is not yet possible to understand whether the object is living. Next, there is a stage (see step 158) in which it is detected whether this object (previously detected as present) is a living body (for example, a human body) or whether it is not a living body (i.e. it is an object): in this stage, therefore, it is possible to distinguish a living body from an object. In this way it is possible to detect reliably whether a part of a living body is located in proximity to the detection system 101.

There will now follow a description of the operation of the detection system 101, also making reference to FIGS. 7 and 10A.

It is assumed that the detection system 101 is positioned inside a shoe (for example, under the insole) and that the part of a living body is a man's foot.

At the initial moment the foot is inserted into the shoe and therefore the temperature of the environment inside the shoe increases; furthermore, the foot remains inserted into the shoe also for the next moments of operation. The optical sensor 102 generates the first infra-red detection signal S_IR1 having a high logical value indicative of the presence of an object in proximity to the system 101 (step 152).

Next, the processing module 107 receives the first infra-red detection signal S_IR1 having the logical value high and processes it (step 155).

In particular, the processing module 107 detects that the first infra-red detection signal S_IR1 has the logical value high and is therefore detecting the presence of an object in proximity to the system 101 (step 157 and transition from step 157 to step 158).

In this stage the processing module 107 is not yet able to understand whether the object detected is living, i.e. is not able to distinguish between an object and a living body.

Next, the infra-red sensor 103 generates the second infra-red detection signal S_IR2 having a logical value high, indicative of the presence of the foot in the shoe (step 153). Furthermore, the temperature sensor 104 detects the increase in temperature caused by the insertion of the foot into the shoe and generates the temperature detection signal S_T indicative of the temperature inside the shoe and having an analogue voltage value greater than a first reference value (step 154). The first reference value is calculated on the basis of the temperature inside the shoe when the man's foot is absent; in the event that the temperature detection signal S_T is an analogue voltage value, the first reference value is for example equal to twice the supply voltage.

Next, the processing module 107 receives the second infra-red detection signal S_IR2 having the logical value high, receives the temperature detection signal S_T having an analogue voltage value greater than the first reference value and processes the values of said signals (step 156). In particular, the processing module 107 in the previous step 157 has detected the presence of the object, then in step 158 it detects that the second infra-red detection signal S_IR2 has the logical value high and that the temperature detection signal S_T has the analogue voltage value greater than the first reference value, reliably detecting, therefore, the presence of the foot in the shoe (step 158 and transition from step 158 to step 159). The processing module 107 therefore generates the presence signal S_P having a logical value high, indicative of the presence of the foot in the shoe.

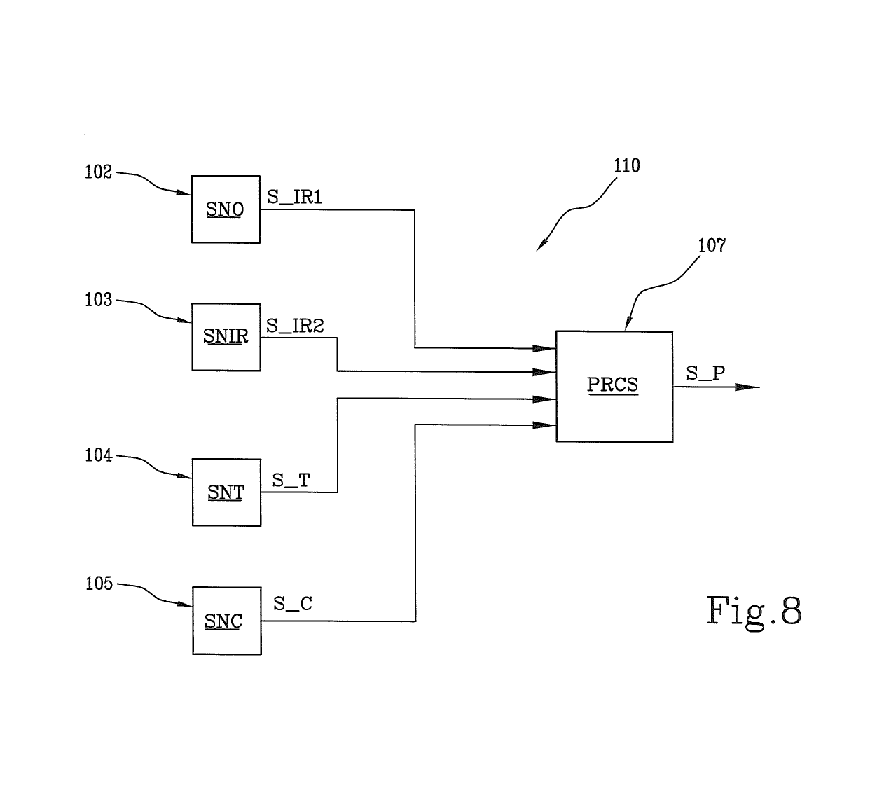

With reference to FIG. 8, a second embodiment is shown of a system for detecting the presence of a part of a living body integrated into the traceable footwear of FIGS. 1 and 2.

The detection system 110 differs from the detection system 101 by the further presence of a capacitive proximity sensor 105, which has the function of detecting the proximity of a living part of a body to the capacitive proximity sensor 105 (and therefore to the detection system 110) by means of the variation in value of a defined capacitance between a metal plate connected to the capacitive proximity sensor 105 and earth. In particular, the capacitive proximity sensor 105 is such as to generate a capacitive detection signal S_C indicative of the variation in capacitance. The processing module 107 is such as to receive the first infra-red detection signal S_IR1 from the optical sensor 102, the second infra-red detection signal S_IR2 from the infra-red sensor 103 and the temperature detection signal S_T from the temperature sensor 104 and the capacitive detection sensor S_C from the capacitive proximity sensor 105 and, depending on these, the processing module 107 is such as to generate the presence signal S_P indicative of the presence or absence of a part of a living body in proximity to the detection system 110. In particular, the processing module 107 comprises the second sub-module configured for processing (in addition to the second infra-red detection signal S_IR2 and the temperature detection signal S_T) also the capacitive detection signal S_C. More particularly, the processing module 107 is such as to verify whether the value of the variation in capacitance is substantially different from a second reference value (or, more generally, is such as to verify whether it is outside a range of reference values), as will be explained in more detail below in the part relating to operation. The second reference value is the capacitance value (between the metal plate and earth) calculated in the conditions in which the part of the living body (for example, the man's foot) is absent. For example, the capacitive detection signal S_C is a logical signal having a first value (for example, high) to indicate that the part of the living body is located in proximity to the detection system 101 (for example, at a distance of less than 1 cm or in contact) and having a second value (in the example, low) to indicate that the part of the living body is not located in proximity to the detection system 101 (for example, at a distance of less than 1 cm or in contact) and having a second value (in the example, low) to indicate that the part of the living body is not located in proximity to the detection system (i.e. in the example it is at a distance greater than 1 cm).

It should be observed that the combination of the sensors 102, 103, 104, 105 is particularly advantageous because it makes it possible to reliably detect the presence of a part of a living body located in proximity to said sensors, given that there is a reduction in the number of false alarm's which can be generated by the individual sensors.

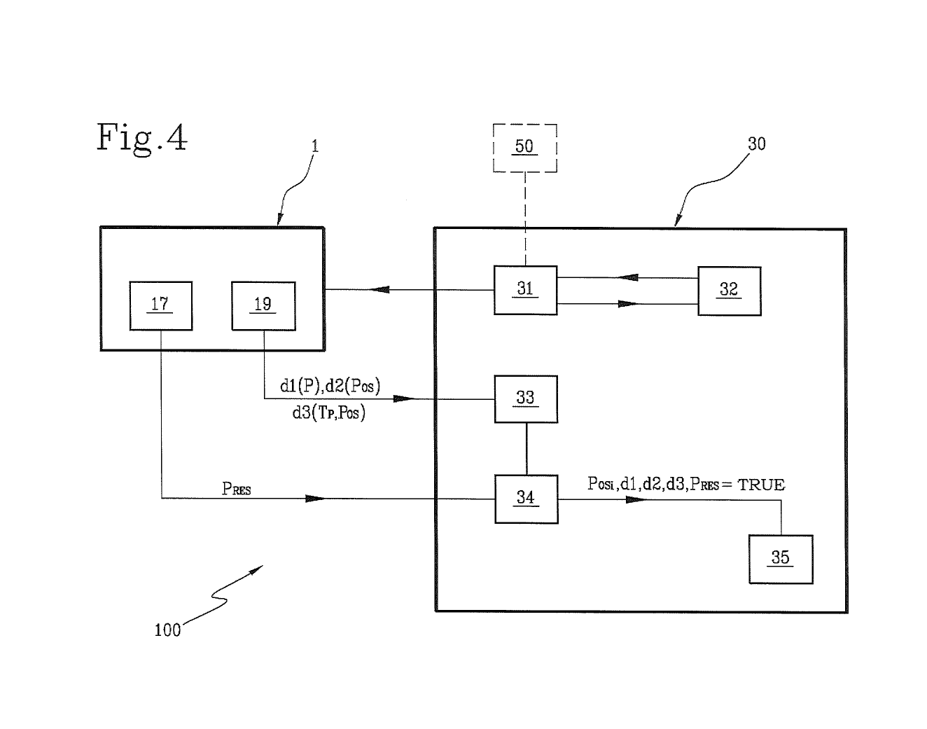

In the second embodiment of the invention, the processing module 7 is such as to execute software code which implements part of the method 150 for detecting the presence of a part of a living body, as shown in FIG. 4B; in particular, the processing module 7 executes steps 155, 157, 162, 163, 164, 151, 161, as will be explained in more detail below in the description relating to operation.

There will now be described the operation of the detection system for detecting the presence of a part of a living body 110 comprised in the presence detection system 17 for detecting the presence of a human being, also making reference to FIGS. 8 and 10B.

The operation of the detection system 110 is similar to that of the detection system 101 previously described up to step 157.

Next, the infra-red sensor 103 generates the second infra-red detection signal S_IR2 having a logical value high, indicative of the presence of the foot in the shoe (step 153). Furthermore, the temperature sensor 104 generates the temperature detection signal S_T indicative of the temperature inside the shoe and having an analogue voltage value greater than the first reference value (step 154). Furthermore the capacitive proximity sensor 105 generates the capacitive detection signal S_C having a value different from the second reference value (step 160).

Next, the processing module 107 receives the second infra-red detection signal S_IR2 having the logical value high, receives the temperature detection signal S_T having an analogue voltage value greater than the first reference value, receives the capacitive detection signal S_C having a value different from the second reference value and processes the values of said signals (step 163). In particular, the processing module 107 in the previous step 157 has detected the presence of the object, then in step 162 it detects that the second infra-red detection signal S_IR2 has the logical value high, detects that the temperature detection signal S_T has the analogue voltage value greater than the first reference value and detects that the capacitive detection signal S_C has the value different from the second reference value, reliably detecting, therefore, the presence of a foot in the shoe (step 162 and transition from step 162 to step 164). The processing module 107 therefore generates the presence signal S_P having a logical value high, indicative of the presence of the foot in the shoe.

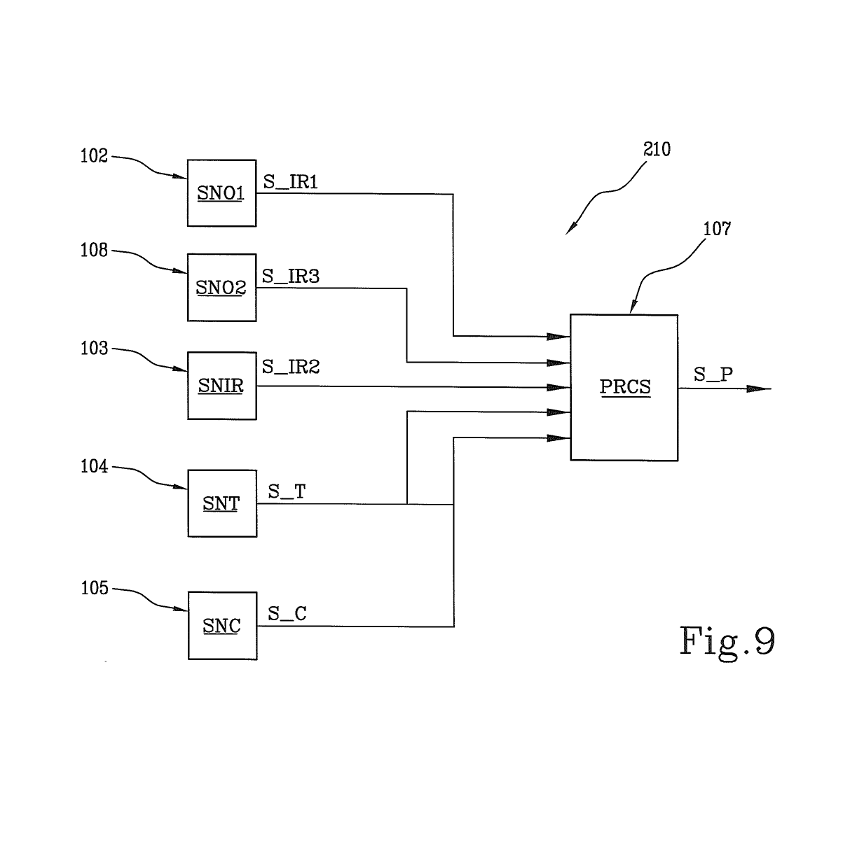

With reference to FIG. 9, a system 210 is shown for detecting the presence of a part of a living body comprised in the presence detection system 17 for detecting the presence of a human being, according to the third embodiment of the invention.

The detection system 210 differs from the detection system 101 because of the presence of a further optical sensor 108 (similar to the optical sensor 102), which has the function of detecting the presence of an object positioned in proximity to the optical sensor 108 and thus positioned in proximity to the system 210. In particular, the optical sensor 108 is such as to generate a third infra-red detection signal S_IR3 indicative of the presence of the object in proximity to the detection system 210 or indicative of the absence of the object. For example, the third infra-red detection signal S_IR3 is a logical signal having a first value (for example, high) to indicate the presence of the object in proximity to the detection system 210 and having a second value (in the example, low) to indicate the absence of the object.

The optical sensor 108 is made for example with the integrated circuit SFH 9240 sold by Osram Opto Semiconductors GmbH (www.osram-os.com) or with the integrated circuit CNY70 sold by Vishay Semiconductors (www.vishay.com).

The optical sensor 108 is positioned at a certain distance from the optical sensor 102.

The processing module 107 is such as to make the comparison between the value of the third infra-red detection signal S_IR3 generated by the optical sensor 108 and the value of the first infra-red detection signal S_IR1 generated by the optical sensor 102: in this way it is possible to discriminate objects of a particular size.

With reference to FIG. 1, advantageously, according to the invention, the footwear further comprises a position detection system 18 configured for detecting a position Pos of the footwear 1 depending on the presence of a human limb in the footwear 1.

In other words, the position detection system 18 is configured for detecting a position Pos of the footwear 1 depending on the parameter Pres.

If Pres=TRUE, then there is a human limb in the footwear.

If Pres=FALSE, then there is not a human limb in the footwear.

Preferably, the position detection system 18 comprises a GPS device.

According to the invention, the position detection system 18 is housed in the movable component 14.

Advantageously, according to the invention, the traceable footwear 1 further comprises a transmission device 19 (FIG. 1) for transmitting data d1, d2, d3 representative of the footwear 1.

The transmission device 19 is configured for transmitting this representative data d1, d2, d3 depending on an external request Req.

Preferably, the transmission device 19 comprises a telephonic transmission card 190.

In particular the card is a SIM card on which is executed a SIM (Subscriber Identity Module) application.

The SIM has the task of securely conserving the unique identification of the owner of the footwear 1 which allows the telephone operator to associate the mobile device into which the SIM is inserted with the profile of a particular customer of its mobile telephony services and, consequently, to associate it with one or more telephone, data and fax numbers.

The SIM-based identification is used in the GSM, GPRS and UMTS networks.

There will now be described a tracking system 100 for tracking a footwear according to the invention.

Advantageously, according to the invention, this system makes it possible to:
track the geographical position of people suffering from mental illnesses which inhibit the orientation system or, in general of any person, in particular children;
track the geographical position for navigation towards a preset position.
track the geographical position of people in danger of aggression.
store the route travelled by the subject monitored.

With particular reference to FIG. 4, the system comprises a traceable footwear 1 as described above.

Advantageously, according to the invention, the system comprises a processing unit 30 configured for processing tracking data representative of the traceable footwear 1.

In general, it should be noted that in the present context and in the subsequent claims, the processing unit 30 is presented as being divided into distinct functional modules (storage modules and operative modules) for the sole purpose of describing clearly and completely the functions of the processing unit 30 itself.

In reality this processing unit 30 can consist of a single electronic device (or card), suitably programmed to perform the functions described, and the different modules can correspond to hardware entities and/or software routines forming part of the programmed device.

Alternatively or in addition, such functions can be performed by a plurality of electronic devices on which the aforementioned functional modules can be distributed.

The processing unit 30 can also make use of one or more processors for executing the instructions contained in the storage modules.

The processing unit 30 comprises a request module 31.

In particular, the processing unit 30 is remotely located with respect to the footwear 1.

The request module 31 is configured for requesting data d1, d2, d3 from the traceable footwear 1, representative of the footwear 1.

The processing unit 30 comprises a timing module 32 configured for timing the request module 31.

The processing unit 30 comprises a reception module 33.

The reception module 33 is configured for receiving first data d1 representative of a person P associated with the traceable footwear 1.

In particular, the reception module 33 is configured for receiving such data from the transmission device 19 of the footwear 1.

The reception module 33 is configured for receiving second data d2 representative of a position Pos of the traceable footwear 1.

The reception module 33 is configured for receiving third data d3 representative of a timing tp of a position Pos represented by the second data d2.

The processing unit 30 comprises a tracking module 34 of the position Pos of the footwear 1.

The tracking module 34 is configured for tracking the position Pos of said footwear 1 on depending on a value=TRUE of said parameter Pres of presence of a human being associated with the footwear 1.

The result of the tracking is a sequence of positions Pos_i occupied over time by the traceable footwear 1.

The processing unit 30 comprises a memory module 35.

The memory module 35 is configured for comprising data d1, d2, d3 representative of the footwear and the position tracking data Pos_i depending on a value=TRUE of the presence parameter Pres.

Advantageously, the invention comprises a network tracking application.

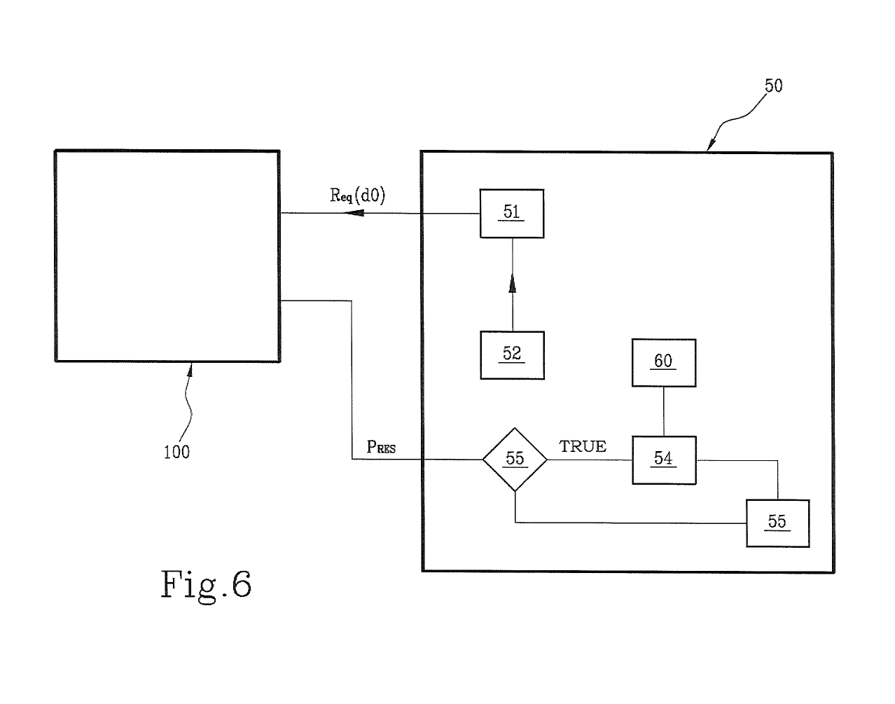

In other words, with particular reference to FIG. 6, the invention provides a data processing device 50 configured for interacting with the tracking system 100 described above.

The processing device comprises, in particular, one of a personal computer, a smartphone, an iPad, a palmtop, a tablet PC, or similar.

The data processing unit 50 comprises a connection module 51.

The connection module 51 is configured for a connection to the tracking system 100.

The data processing unit 50 comprises a send and request module 52.

The send and request module is configured for sending data d0 representative of a traceable footwear 1 and for a request Req for information.

In other words, from the data processing device 50, a user requests for a subject to be monitored by sending an identification of the footwear 1 and asking whether the user is present.

The send and request module 52 is configured for requesting a status of the presence parameter Pres, by means of the request signal Req.

In other words, monitoring the subject's position can be started only if the presence of the said subject is first detected.

In a preferred embodiment, the data processing device 50 is a smartphone and the user is interested in monitoring the movements of a child associated with a footwear identified by data d0.

In this preferred embodiment, the functions of the above modules are performed by a smartphone application APP downloadable from a dedicated website.

In other words, in the preferred embodiment, the data processing device 50 comprises a smartphone and the functions of one or more of the aforementioned modules are performed by the smartphone application APP.

The data processing unit 50 comprises a start module 54 for starting the tracking system 100.

Advantageously, according to the invention, the start module 54 is preceded by a comparison module 55 configured for assessing the value of the parameter Pres.

According to the invention, the module 54 is configured for activating the tracking module 100 depending on a value=TRUE of the presence parameter Pres.

The data processing unit 50 comprises a blocking module 55 for blocking the tracking system 100.

The blocking module 55 is configured for blocking the tracking system 100 at a new event or change in the value of the parameter Pres from TRUE to FALSE.

The simulation is displayed on a user interface 60.

The invention as described achieves the advantages of facilitating the traceability of a footwear for all types of user, child or adult.

The system, furthermore, is easy to use and makes it possible to perform efficient detection even at great distances and to store the constructed route.

1. A traceable footwear, particularly for children, comprising
a circuit terminal mounted permanently in said footwear;
a housing comprising a first electrical contact connected to said circuit terminal;
a movable component removably inserted in said housing, wherein the movable component is provided with a second electrical contact, said first and second electrical contacts being configured to come into contact with one another depending on the insertion of said movable component in said housing;
wherein said movable component further comprises:
a detection system for detecting the presence of a human being;
at least one detection sensor for detecting the presence of a part of a living body;
wherein said detection system for detecting the presence of a human being is configured for detecting a parameter representative of the presence of a human being when said first and second electrical contacts are in contact with one another, and depending on a first detection signal indicative of the presence or absence of an object in proximity to said detection sensor for detecting the presence of a part of a living body;
a position detection system configured for detecting a position of said footwear depending on said parameter.

2. The traceable footwear according to claim 1, wherein said position detection system comprises a GPS device.

3. The traceable footwear according to claim 1, comprising a sole wherein said circuit terminal is mounted and said housing is formed.

4. The traceable footwear according to claim 1, comprising a transmitting device for transmitting data representative of said footwear.

5. The traceable footwear according to claim 4, wherein said transmitting device for transmitting representative data is configured for transmitting said representative data depending on an external request.

6. The traceable footwear according to claim 4, wherein said transmitting device comprises a card for telephonic transmission.

7. The traceable footwear according to claim 1 wherein said at least one detection sensor for detecting the presence of a part of a living body comprises an optical sensor.

8. (canceled)

9. The traceable footwear according to claim 1, wherein said detection system for detecting the presence of a human being further comprises a passive infrared sensor configured for detecting the infrared electromagnetic radiation emitted by the part of the living body and generating therefrom a second infrared detection signal indicative of the presence or absence of the part of the living body in proximity to the infrared sensor.

10. The traceable footwear according to claim 9, wherein said detection system for detecting the presence of a human being comprises a temperature sensor configured for generating a temperature detection signal indicative of the temperature of an environment present in the vicinity of the part of the living body.

11. The traceable footwear according to claim 10, wherein said detection system for detecting the presence of a human being further comprises a capacitive proximity sensor configured for detecting a change in a capacitance value in the case of the living body being near the capacitive proximity sensor and for generating therefrom a capacitive detection signal indicative of the change in capacitance.

12. A tracking system for tracing a footwear, comprising:
a traceable footwear according to claim 1;
a processing unit configured for processing data representative of said traceable footwear, comprising:
a request module configured for requesting data representative of said footwear;
a timing module configured for timing said request module;
a reception module configured for receiving:
first data representative of a person associated with said traceable footwear;
second data representative of a position of said traceable footwear;
third data representative of a timing of a position representative of said second data;
a tracking module for tracking said position of said footwear configured for tracking the position of said footwear depending on a value=TRUE of said parameter of presence of a human being associated with said footwear;
a memory module configured for comprising said data representative of said footwear and said data for tracing the position thereof depending on a value=TRUE of said presence parameter.

13. A data processing device configured for interacting with the system described in claim 12, wherein the device comprises:
a connection module for connection to said tracking system;
a sending and request module configured for sending data representative of a traceable footwear and for a request for information on the presence of a user referring to said footwear;
a start module for starting said tracing system, configured for activating said tracing system depending on a value=TRUE for said parameter regarding the presence of a user;
a blocking module for said tracking system configured for blocking said tracking system at each new event or change in the value of said parameter from TRUE to FALSE.

14. A data processing device according to claim 13 wherein said device comprises a personal computer, or one of a smartphone, an iPad, a palmtop, a tablet PC, or similar.

15. A data processing device according to claim 14 wherein said device comprises a smartphone and the functionalities of one or more of the aforesaid modules are realized by a smartphone application.

16. The traceable footwear according to claim 2, comprising a sole wherein said circuit terminal is mounted and said housing is formed.

17. The traceable footwear according to claim 2, comprising a transmitting device for transmitting data representative of said footwear.

18. A traceable garment comprising
a circuit terminal mounted permanently in said garment;
a housing comprising a first electrical contact connected to said circuit terminal;
a movable component removably inserted in said housing, wherein the movable component is provided with a second electrical contact, said first and second electrical contacts being configured to come into contact with one another depending on the insertion of said movable component in said housing;
wherein said movable component further comprises:
a detection system for detecting the presence of a human being comprising a system for detecting the presence of a part of a living body;
wherein said detection system for detecting the presence of a human being is configured for detecting a parameter representative of the presence of a human being when said first and second electrical contacts are in contact with one another, and depending on a first detection signal indicative of the presence or absence of an object in proximity to said detection sensor for detecting the presence of a part of a living body;
a position detection system configured for detecting a position of said garment depending on said parameter.

19. The traceable garment according to claim 18 wherein said movable component further comprises at least one detection sensor for detecting the presence of a part of a living body.

20. A traceable clothing accessory comprising:
a circuit terminal mounted permanently in said clothing accessory;
a housing comprising a first electrical contact connected to said circuit terminal;
a movable component removably inserted in said housing, wherein the movable component is provided with a second electrical contact, said first and second electrical contacts being configured to come into contact with one another depending on the insertion of said movable component in said housing;
wherein said movable component further comprises:
a detection system for detecting the presence of a human being comprising a system for detecting the presence of a part of a living body;
wherein said detection system for detecting the presence of a human being is configured for detecting a parameter representative of the presence of a human being when said first and second electrical contacts are in contact with one another, and depending on a first detection signal indicative of the presence or absence of an object in proximity to said detection sensor for detecting the presence of a part of a living body;
a position detection system configured for detecting a position of said clothing accessory depending on said parameter.

21. The traceable clothing accessory according to claim 20 wherein said movable component further comprises at least one detection sensor for detecting the presence of a part of a living body.
